(19) United States
(12) Patent Application Publication
(10) Pub. No.: US 2010/0118127 A1
(43) Pub. Date: May 13, 2010

(54) Wide depth of field 3D display apparatus and method

(75) Inventors: Dong Kyung Nam, Yongin-si (KR); Yun-Tae Kim, Suwon-si (KR); Du-Sik Park, Suwon-si (KR); Gee Young Sung, Daegu-si (KR); Ju-Yong Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/453,174

(22) Filed: Apr. 30, 2009

(30) Foreign Application Priority Data
Nov. 13, 2008 (KR) 10-2008-0112825

(51) Int. Cl. H04N 13/04

(52) U.S. Cl. 348/51; 348/E13.075

(57) ABSTRACT

A display apparatus and method that may display a high depth three-dimensional (3D) image is provided. The display method may separate an input image into a near-sighted image and a far-sighted image, image and output the near-sighted image using a light field method, and image and output the far-sighted image using a multi-view method.

### CROSS-REFERENCE TO RELATED APPLICATIONS

This application claims the benefit of Korean Patent Application No. 10-2008-0112825, filed on Nov. 13, 2008 in the Korean Intellectual Property Office, the disclosure of which is incorporated herein by reference.

### BACKGROUND

1. Field

One or more embodiments relate to a display apparatus and method that may display a high depth three-dimensional (3D) image, and more particularly, to a technology that may separate an image into a near-sighted image and a far-sighted image to output the near-sighted image using a light field method and to output the far-sighted image using a multi-view method and thereby may prevent the image from being blurred or being overlapped to output a high quality of image.

2. Description of the Related Art

A three-dimensional (3D) display apparatus denotes an image display apparatus that may three-dimensionally display an image. In order to more actually embody a 3D effect, the 3D display apparatus may more sufficiently provide depth cues to make it possible for a user to feel the 3D effect. This is different from a two-dimensional (2D) display apparatus. The depth cues may include a stereo disparity, a convergence, an accommodation, a motion parallax, and the like.

Representative methods of an auto-stereoscopic display apparatus that does not use glasses may adopt a multi-view scheme and a light field method. However, when embodys a 3D display image using the multi-view method and the light field method, the multi-view method may cause blurring of the image and a visual fatigue to occur in displaying a near-sighted image that is positioned between a display panel and a user. The light field method may blur the image in displaying a far-sighted image that is positioned behind the display panel.

Accordingly, there is a need for a research regarding an excellent 3D display technology that may overcome limits found in an existing 3D display technology and may prevent blurring or overlapping of an image and thereby enhance an image quality.

### SUMMARY

Additional aspects and/or advantages will be set forth in part in the description which follows and, in part, will be apparent from the description, or may be learned by practice of the invention.

According to an aspect of one or more embodiments, a display method including: separating an input image into a near-sighted image and a far-sighted image; imaging the near-sighted image using a light field method and imaging the far-sighted image using a multi-view method; and weaving and outputting the imaged near-sighted image and the far-sighted image is provided.

In this instance, the method may further include extracting a depth of the input image to generate a depth map. The separating of the input image may include separating the input image into the near-sighted image and the far-sighted image based on the depth map.

Also, the separating of the input image may include separating, as the near-sighted image, an image that is positioned between a display panel and a user, and separating, as the far-sighted image, an image that is positioned behind the display panel.

Also, the method may further include performing an interpolation or an extrapolation for the input image, when a number of viewpoints of the input image is different from a number of viewpoints of an output image to be output.

Also, the method may further include: verifying a location of a user; and controlling a sweet spot of an output image to be output according to the location of the user.

According to another aspect of one or more embodiments, a display apparatus including: an image separating unit to separate an input image into a near-sighted image and a far-sighted image; a near-sighted image imaging unit to image the near-sighted image using a light field method; a far-sighted image imaging unit to image the far-sighted image using a multi-view method; an image weaving unit to weave the imaged near-sighted image and the far-sighted image; and an image output unit to output the weaved image is provided.

In this instance, the display apparatus may further include a depth extraction unit to extract a depth of the input image to generate a depth map.

Also, the display apparatus may further include an image interpolation unit to perform an interpolation or an extrapolation for the input image, when a number of viewpoints of the input image is different from a number of viewpoints of an output image to be output.

Also, the display apparatus may further include: a location verification unit to verify a location of a user; and a control unit to control a sweet spot of an output image to be output according to the location of the user.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a flowchart illustrating a display method for displaying a high depth three-dimensional (3D) image according to an embodiment;

FIG. 2 is a flowchart illustrating an operation of imaging a near-sighted image and a far-sighted image of FIG. 1;

FIG. 3 is a flowchart illustrating an operation of weaving and outputting the near-sighted image and the far-sighted image of FIG. 1;

FIG. 4 is a flowchart illustrating an operation of controlling a sweet spot of an output image according to an embodiment;

FIG. 5 illustrates an example of displaying a high depth 3D image according to an embodiment;

FIG. 6 illustrates a process of displaying a near-sighted image and a far-sighted image using different methods, respectively, depending on a format of an input image according to an embodiment;

FIG. 7 illustrates a process of displaying a high depth 3D image when a stereo image is input according to an embodiment; and

FIG. 8 is a block diagram illustrating a display apparatus for displaying a high depth 3D image according to an embodiment.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present disclosure by referring to the figures.

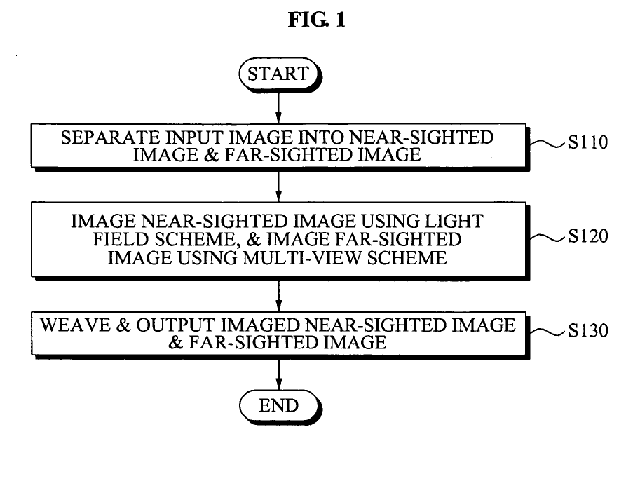

FIG. 1 is a flowchart illustrating a display method for displaying a high depth three-dimensional (3D) image according to an embodiment.

Referring to FIG. 1, in operation S110, the display method may separate an input image into a near-sighted image and a far-sighted image. In this instance, an image that is positioned closer to a user based on a display panel may be separated into the near-sighted image. An image that is positioned away from the user based on the display panel may be separated into the far-sighted image.

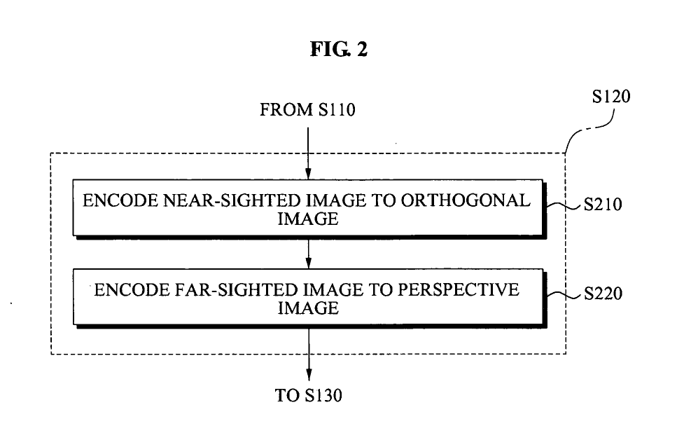

In operation S120, the display method may image the near-sighted image using a light field method, and may image the far-sighted image using a multi-view method. Hereinafter, operation S120 will be further described in detail with reference to FIG. 2.

FIG. 2 is a flowchart illustrating operation 120 of imaging the near-sighted image and the far-sighted image of FIG. 1.

Referring to FIG. 2, in operation S210, the display method may encode the near-sighted image to an orthogonal image.

In operation S220, the display method may encode the far-sighted image to a perspective image.

Specifically, the display method may encode the near-sighted image to the orthogonal image to output the near-sighted image using the light field method. Also, the display method may encode the far-sighted image to the perspective image in order to output the far-sighted image using the multi-view method.

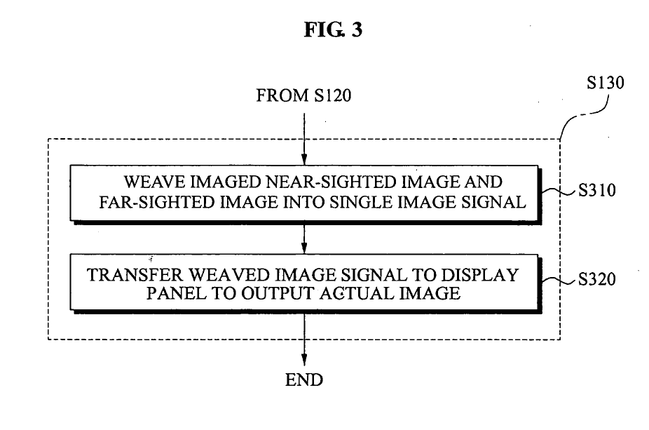

Referring again to FIG. 1, in operation S130, the display method may weave and output the imaged near-sighted image and the far-sighted image. Hereinafter, operation S130 will be further described in detail with reference to FIG. 3.

FIG. 3 is a flowchart illustrating operation S130 of weaving and outputting the near-sighted image and the far-sighted image of FIG. 1.

Referring to FIG. 3, in operation S310, the display method may weave the imaged near-sighted image and far-sighted image into a single image signal.

In operation S320, the display method may transfer the weaved image signal to a display panel to output an image.

Specifically, the display method may sequentially weave the near-sighted image and the far-sighted image that are imaged to the orthogonal image and the perspective image, respectively into a single image, and thereby make them into a single image frame. Accordingly, when the weaved image signal is transferred to a 3D display panel, it is possible to output an actual image.

According to an embodiment, the display method may further include extracting a depth of the image to generate a depth map. For example, when the input image is in a stereo format, a multi-view format, and the like, and the input image is received, it is possible to extract a depth of the input image to generate the depth map. Accordingly, the input image is separated into a near-sighted image and a far-sighted image based on the generated depth map. When the input image is in a 3D format having color and depth information, the input image can be separated into the near-sighted image and the far-sighted image without generating the depth map.

Also, according to an embodiment, when a number of viewpoints of the input image is different from a number of viewpoints of an output image to be output, the display method may further include performing an interpolation or an extrapolation for the input image. For example, when the input image is a 6-viewpoint image and the output image is a 24-viewpoint image, the display method may perform the interpolation or the extrapolation for the input image to output the input image as the 24-viewpoint image.

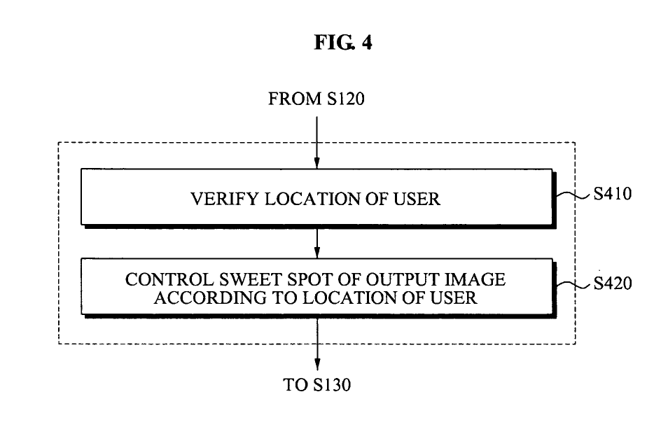

Also, according to an embodiment, the display method may further include verifying a location of a user, and controlling a sweet spot of an output image to be output according to the location of the user. Here, the operation of controlling the sweet spot of the output image will be further described in detail with reference to FIG. 4.

FIG. 4 is a flowchart illustrating an operation of controlling a sweet spot of an output image according to an embodiment.

Referring to FIG. 4, in operation S410, the display method may verify a location of a user via a vision and the like. In operation S420, the display method may control the sweet spot of the output image according to the location of the user, so that the user may view an enhanced quality of image. Here, the sweet spot of the output image may be controlled by changing an interval between a display panel and a lens, or by shifting the output image.

As described above, each of a multi-view display method and a light field display method may adopt a different method to obtain and display an image. However, the multi-view display method and the light field display method may be embodied through the same display structure. Specifically, both methods may attach a lenticular lens onto a 2D display panel to thereby display a 3D image, or may be embodied in a form of a multi-projector. Accordingly, both the near-sighted image and the far-sighted image can be outputted cleaning by separating the input image into a multi-view image and a light field image according to a depth.

Also, according to an embodiment, the input image may be separated into the near-sighted image and the far-sighted image. The near-sighted image may be imaged and be output using the light field method. The far-sighted image may be imaged and be output using the multi-view method. Through this, the user may view the enhanced image without blurring or overlapping of the image.

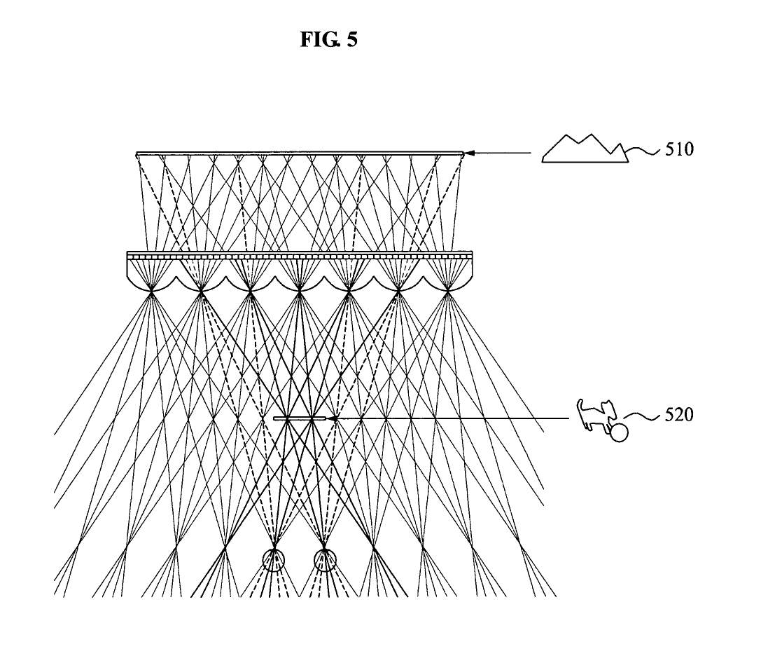

FIG. 5 illustrates an example of displaying a high depth 3D image according to an embodiment.

Referring to FIG. 5, when displaying a near-sighted image 520 using a light field method, and displaying a far-sighted image 510 using a multi-view method, both the near-sighted image 520 and the far-sighted image 510 are displayed without causing burring or overlapping. As shown in FIG. 5, since the near-sighted image 520 is displayed in front of the far-sighted image 510, there may be no need to display a portion of the far-sighted image 520 that is overlapped with the near-sighted image 510. Therefore, beams for displaying the near-sighted image 520 may not be overlapped with beams corresponding to the far-sighted image 510. This may apply to whichever direction the user views a corresponding image. According to an embodiment, a near-sighted image and a far-sighted image may be separated from each other and thereby be expressed using different methods, respectively.

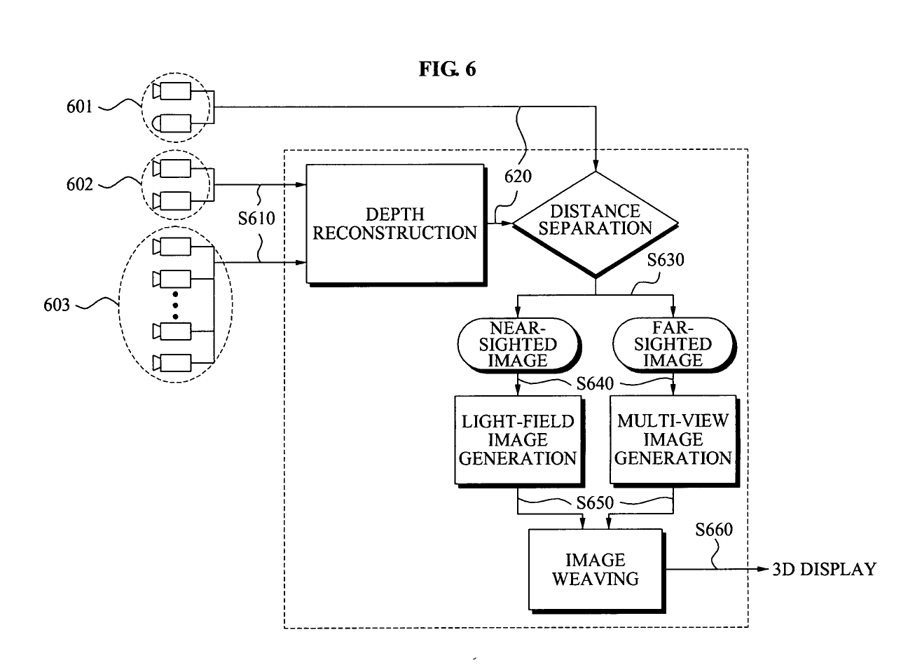

FIG. 6 illustrates a process of displaying a near-sighted image and a far-sighted image using different methods, respectively, depending on a format of an input image according to an embodiment.

Referring to FIG. 6, in operation S610, when a 3D image is received as the input image, a depth of the input image may be extracted to generate a depth map. Here, the 3D image may be in at least one of a 3D format 601 containing color and depth information, a stereo format 602, and a multi-view format 603. If it is possible to express a depth effect, any type of input may be used. When the input 3D image is in the 3D format 601 containing the color and depth information, operation S610 may not be performed.

In operation S620, it may be determined whether to display the 3D image in front of a display panel or behind the display panel. In operation S630, the 3D image may be separated into a near-sighted image and a far-sighted image.

In operation S640, the near-sighted image and the far-sighted image may be generated into a light field image and a multi-view image, respectively. Specifically, the near-sighted image may be encoded to an orthogonal image, and the far-sighted image may be encoded to a perspective image.

In operation S650, the encoded images may be sequentially weaved into a single image to thereby generate a single image frame. In operation S660, a final image signal where the near-sighted image and the far-sighted image are weaved may be transferred to a 3D display to thereby display an actual image.

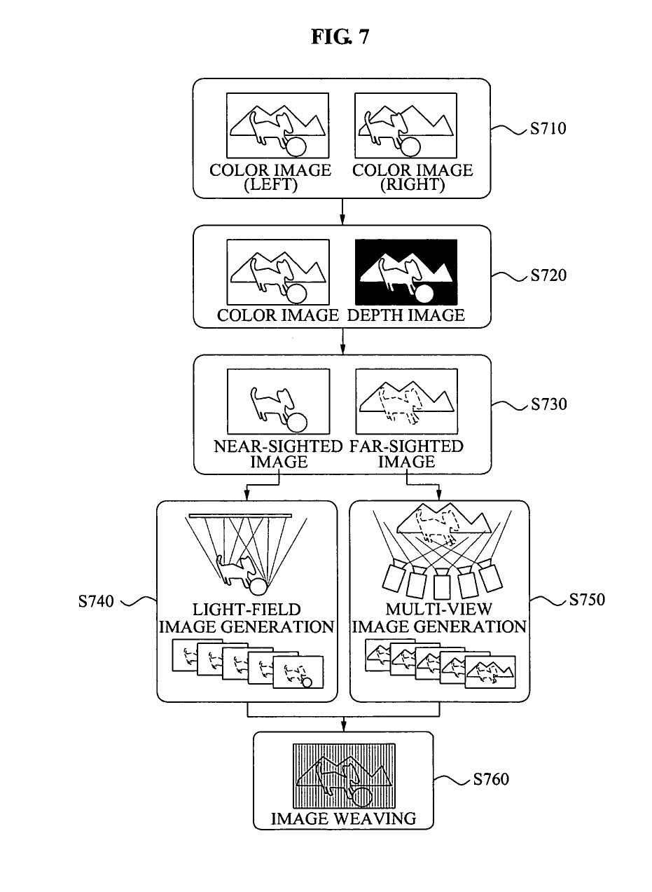

FIG. 7 illustrates a process of displaying a high depth 3D image when a stereo image is input according to an embodiment.

Referring to FIG. 7, in operation S710, a stereo image including a left image and a right image may be input.

In operation S720, a color image containing color information and a depth image containing depth information may be extracted from the stereo image.

In operation S730, a near-sighted image and a far-sighted image may be separated using the color image and the depth image. In this instance, the near-sighted image and the far-sighted image may be separated depending on whether an image is output from a region that is located closer to a user based on a display panel, or whether the image is output from a region that is located away from the user based on the display panel. For this, the near-sighted image or the far-sighted image may be separated by comparing an image value and a predetermined parameter value.

In operation S740, when the image is the near-sighted image, a light field image may be generated to output the near-sighted image using a light field method. Specifically, the near-sighted image may be encoded to an orthogonal image for the output of the light field method.

In operation S750, when the image is the far-sighted image, a multi-view image may be generated to output the far-sighted image using a multi-view method. Specifically, the far-sighted image may be encoded to a perspective image for the output of the multi-view method.

In operation S760, the imaged near-sighted image and the far-sighted image may be weaved to generate a single image frame.

As described above, according to an embodiment, since the near-sighted image and the far-sighted image that are imaged using respective different methods are weaved and thereby output, it is possible to clearly display both the near-sighted image and the far-sighted image, without causing blurring or overlapping of an image.

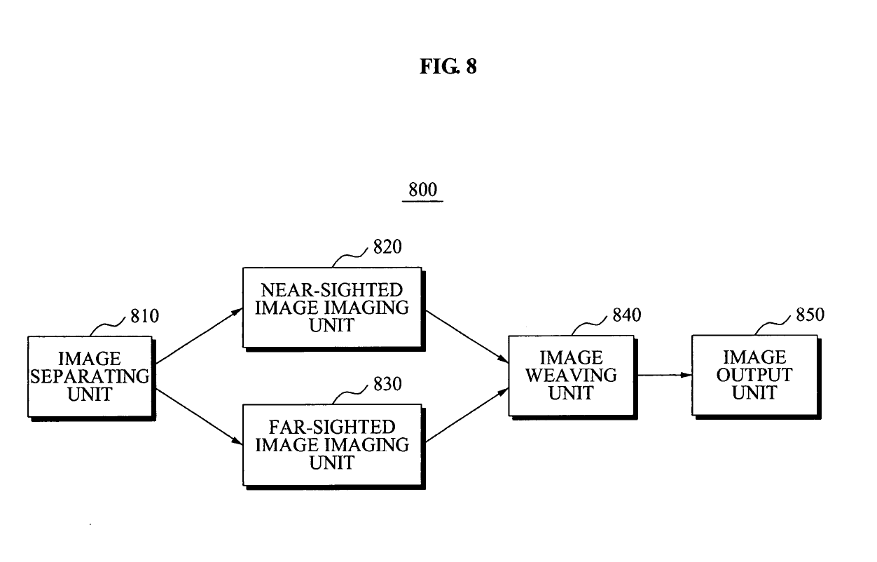

FIG. 8 is a block diagram illustrating a display apparatus 800 for displaying a high depth 3D image according to an embodiment.

Referring to FIG. 8, the display apparatus 800 may include an image separating unit 810, a near-sighted image imaging unit 820, a far-sighted image imaging unit 830, an image weaving unit 840, and an image output unit 850. Also, although not shown in FIG. 8, the display device 800 may further include at least one of a depth extraction unit, an image interpolation unit, a location verification unit, and a control unit.

The image separating unit 810 may separate an input image into a near-sighted image and a far-sighted image. The near-sighted image and the far-sighted image may be separated depending on an output location based on a display unit, or may be determined through a comparison with a predetermined parameter value.

The near-sighted image imaging unit 820 may image the near-sighted image using a light field method. Accordingly, the near-sighted image may be encoded to an orthogonal image.

The far-sighted image imaging unit 830 may image the far-sighted image using a multi-view method. Accordingly, the far-sighted image may be encoded to a perspective image.

The image weaving unit 840 may weave the imaged near-sighted image and the far-sighted image. Specifically, the near-sighted image and the far-sighted image may be weaved to generate a single frame image.

The image output unit 850 may output the weaved image.

The depth extraction unit may extract a depth of the input image to generate a depth map. For example, when the input image is a stereo image or a multi-view image, the depth extraction unit may extract the depth to generate the depth map of the image.

When a number of viewpoints of the input image is different from a number of viewpoints of an output image to be output, the image interpolation unit may perform an interpolation or an extrapolation for the input image.

The location verification unit may verify a location of a user. The control unit may control a sweet spot of the output image according to the location of the user. For example, the control unit may change the sweet spot of the output image in correspondence to a location change according to a motion of the user.

As described above, according to an embodiment, an input image may be separated into a near-sighted image and a far-sighted image. The near-sighted image and the far-sighted image may be imaged and output using different methods, respectively. Through this, it is possible to embody a 3D display apparatus that may prevent burring or overlapping of an image and enables the user to view the image in a relatively wider view range, without feeling a visual fatigue.

The aforementioned display type or structure is only an example. Thus, when embodying a 3D display apparatus, there may be some difference. Specifically, a projector method may be used to embody a multi-view image and a light field image. Also, a micro array lens may be adopted instead of using a lenticular lens. Any modification found in embodying this display apparatus, or in generating the multi-view image and the light field image may be included in the spirit and scope of the embodiments.

The high depth 3D image display method according to the above-described example embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. A display method comprising:
separating an input image into a near-sighted image and a far-sighted image;
imaging the near-sighted image using a light field method and imaging the far-sighted image using a multi-view method; and
weaving and outputting the imaged near-sighted image and the far-sighted image.

2. The method of claim 1, further comprising:
extracting a depth of the input image to generate a depth map,
wherein the separating of the input image comprises separating the input image into the near-sighted image and the far-sighted image based on the depth map.

3. The method of claim 1, wherein the separating of the input image comprises separating, as the near-sighted image, an image that is positioned between a display panel and a user, and separating, as the far-sighted image, an image that is positioned behind the display panel.

4. The method of claim 1, wherein the imaging comprises:
encoding the near-sighted image to an orthogonal image; and
encoding the far-sighted image to a perspective image.

5. The method of claim 1, further comprising:
performing an interpolation or an extrapolation for the input image, when a number of viewpoints of the input image is different from a number of viewpoints of an output image to be output.

6. The method of claim 1, wherein the outputting comprises:
weaving the imaged near-sighted image and the far-sighted image into a single image signal; and
transferring the weaved image signal to a display panel to output an image.

7. The method of claim 1, further comprising:
verifying a location of a user; and
controlling a sweet spot of an output image to be output according to the location of the user.

8. The method of claim 7, wherein the controlling of the sweet spot comprises changing an interval between a display panel and a lens to control the sweet spot of the output image.

9. The method of claim 7, wherein the controlling of the sweet spot comprises shifting the output image to control the sweet spot of the output image.

10. A computer-readable recording medium storing a program for implementing the method of claim 1.

11. A display apparatus comprising:
an image separating unit to separate an input image into a near-sighted image and a far-sighted image;
a near-sighted image imaging unit to image the near-sighted image using a light field method;
a far-sighted image imaging unit to image the far-sighted image using a multi-view method;
an image weaving unit to weave the imaged near-sighted image and the far-sighted image; and
an image output unit to output the weaved image.

12. The display apparatus of claim 11, further comprising:
a depth extraction unit to extract a depth of the input image to generate a depth map.

13. The display apparatus of claim 11, wherein the image separating unit separates, as the near-sighted image, an image that is positioned between a display panel and a user, and separates, as the far-sighted image, an image that is positioned behind the display panel.

14. The display apparatus of claim 11, wherein the near-sighted image imaging unit encodes the near-sighted image to an orthogonal image.

15. The display apparatus of claim 11, wherein the far-sighted image imaging unit encodes the far-sighted image to a perspective image.

16. The display apparatus of claim 11, further comprising:
an image interpolation unit to perform an interpolation or an extrapolation for the input image, when a number of viewpoints of the input image is different from a number of viewpoints of an output image to be output.

17. The display apparatus of claim 11, further comprising:
a location verification unit to verify a location of a user; and
a control unit to control a sweet spot of an output image to be output according to the location of the user.

18. The display apparatus of claim 17, wherein the control unit changes an interval between a display panel and a lens to control the sweet spot of the output image.

19. The display apparatus of claim 17, wherein the control unit shifts the output image to control the sweet spot of the output image.
